(19) United States
(12) Patent Application Publication
(10) Pub. No.: US 2002/0184061 A1
(43) Pub. Date: Dec. 5, 2002

(54) Method and system for managing executive information

(76) Inventors: Thomas A. Digate, Fort Wayne, IN (US); Don McDonald, Fort Wayne, IN (US); William Bledsoe, Fort Wayne, IN (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,768

(22) Filed: Jun. 1, 2001

(51) Int. Cl. G06F 17/60

(52) U.S. Cl. 705/7

(57) ABSTRACT

A computer network-based method for managing information relating to business objectives includes, for example, providing a server into which users enter information relating to business objectives, and from which users obtain information relating to progress toward achieving business objectives.

### COPYRIGHT STATEMENT

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

This invention relates to computer network-based communication systems, and more particularly, to computer network-based methods and systems for managing information used by business executives.

The global computer network known as the Internet has produced a dramatic improvement in electronic communications and information access. Particularly with the introduction of the World Wide Web, and the use of remote terminals and local area networks connected with the Internet, individuals and organizations are now able to easily communicate electronically, by sending messages, and relaying, displaying and accessing information.

Despite the advantages offered by the Internet, many large organizations continue to face problems in intra-organizational communications. In particular, organizations having widely dispersed employees working on the same project face difficulties in disseminating objectives and monitoring employees' progress toward attaining those objectives. It is difficult for a manager to ensure that all project participants, who may be scattered across the world, know the goals that the manager is trying to achieve, how each project participant's objectives contribute toward those goals, and how the goals relate to the business objectives set forth by the corporation.

The manager also must devise a method to gather information on progress toward achieving those goals, and to report that progress to other layers of management.

Typically every employee and manager has a separate tracking and reporting system, leading to divergent approaches and an unwieldy process when a company grows beyond a certain size. Each manager must collate the progress of each individual to produce a summary of the progress for the entire team. The next higher manager is faced with the same summarization task. At the highest level of management questions pertaining to the status of an individual team or person can only be answered by walking the summarization chain backwards, through each of the personalized systems that were used to create the summaries initially. This problem impedes the flow of information up and down the management structure, and thereby imposes a cost in time, efficiency, and potentially performance.

In addition to these tasks facing the manager, the individual employee must track his progress toward fulfilling those goals, not least for purposes of any future performance appraisal. As with any annual process, the employee may only consider his accomplishments and results at the time of performance appraisal, instead of ideally as they occur. Few employees actually do this, however, and even if they were to do so, the absence of a standardized format would lead to a multitude of idiosyncratic approaches, thereby compounding the summarization problem facing the employee's manager. Furthermore, most corporations use manual methods that entail substantial effort by employees. Even those that provide a computerized user interface for entering information still rely upon manual summarization of the information for reporting purposes, with consequent duplication of effort expended in combining information into summary results.

It would therefore be desirable to provide computer network-based methods and systems for disseminating business objectives both for project groups and for each of the project participants. It would also be desirable to provide methods and systems for tracking the progress of the project group and of each member of that group toward achieving those objectives. It would further be desirable to provide such dissemination and tracking abilities that function in real-time. It would also be desirable to provide computer network-based methods and systems that provide uniformity in the form of the tracking and reporting, while permitting flexibility in their content.

### SUMMARY OF INVENTION

In one embodiment of the invention, a personal scorecard provides managers with a simple and easy way of disseminating business objectives to their employees around the world, and tracking their progress toward meeting those objectives. The scorecard simplifies the manager's task in preparing progress reports by providing a consistent format while allowing flexibility in content. With a “roll up” method of the system, the scorecard provides managers with instant information as objectives are met. It also provides employees with an easy and convenient method to obtain their objectives, to track their progress toward meeting their objectives, and to record achievements as they occur. With the personal scorecard, performance appraisals become a matter of transferring the information from the scorecard to the performance appraisal. The personal scorecard thus reduces the burden on the employee and ensures that all accomplishments will be noted.

In an exemplary embodiment, a computer network-based method for disseminating business objectives and tracking progress toward achieving these objectives is implemented through use of a Web-based system. The system includes a central server containing multiple Web-enabled clients, and multiple interactive Web pages linked to or within multiple Web-based pages corresponding to individual projects for which results are tracked. The Web pages are used to access and store information relating to business objectives in the Web-enabled databases, and to track progress toward achieving these objectives as described below. Elements of the system are accessible by remote users with a user interface such as a Web-browser on a computer coupled to the computer network.

### BRIEF DESCRIPTION OF DRAWINGS

FIG. 1 is a schematic diagram of an exemplary network-based system for implementing a method in accordance with one embodiment of the invention.

FIG. 2 is an expanded version block diagram of an exemplary embodiment of a server architecture of an alternative system.

FIG. 3 is a flow diagram of a network-based personal scorecard system.

FIG. 4 is an exemplary embodiment of a personal value scorecard Six Sigma and IP page.

FIG. 5 is an exemplary embodiment of a personal value scorecard organization and targets page.

FIG. 6 is an exemplary embodiment of a personal value Atlas projects page.

FIG. 7 is an exemplary embodiment of a personal scorecard productivity and customers page.

FIG. 8 is an exemplary embodiment of a personal scorecard report generation page.

FIG. 9 is an exemplary embodiment of a personal scorecard CTQ drilldown page.

FIG. 10 is an exemplary embodiment of a personal scorecard report page.

FIG. 11 is a continuation page of the personal scorecard report page shown in FIG. 10.

FIG. 12 is a further continuation page of the personal scorecard report page shown in FIG. 10.

### DETAILED DESCRIPTION

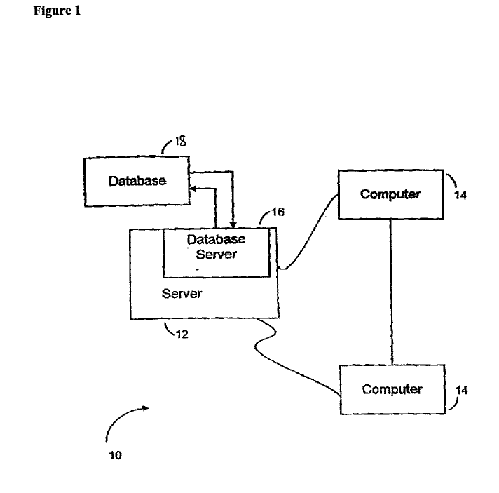

FIG. 1 is a block diagram of a personal scorecard system 10 in accordance with one embodiment of the present invention. System 10 includes a server sub-system 12 and a plurality of user devices 14 connected to server sub-system 12, sometimes referred to herein as server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a web-based phone or other web-based connectable equipment. Server sub-system 12 includes a database server 16 connected to a centralized database 18 containing personal scorecard information, as described below in greater detail. In one embodiment, centralized database 18 is stored on database server 16 and can be accessed by potential users at one of user devices 14 by logging onto server sub-system 12 through one of user devices 14. In an alternative embodiment centralized database 18 is stored remotely from server sub-system 12.

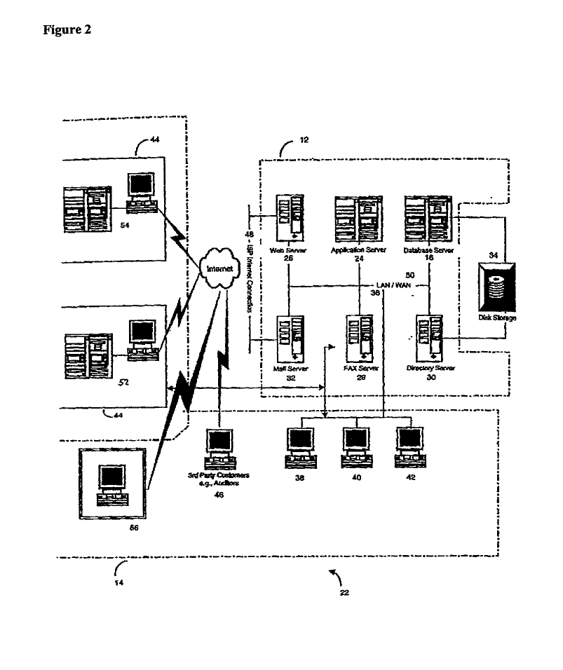

FIG. 2 is an expanded version block diagram of an exemplary embodiment of a server architecture of a personal scorecard system 22. Components of system 22, identical to components of system 10 (shown in FIG. 1), are identified in FIG. 2 using the same reference numerals as used in FIG. 1. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to users 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any authorized individual or an employee of the business entity having a workstation 52 can access server sub-system 12. One of user devices 14 includes a senior manager's workstation 54 located at a remote location. Workstations 52 and 54 are personal computers having a web browser. Also, workstations 52 and 54 are configured to communicate with server sub-system 12. Furthermore, fax server 28 communicates with employees located outside the business entity and any of the remotely located user systems, including a user system 56 via a telephone link. Fax server 28 is configured to communicate with other workstations 38, 40, and 42 as well.

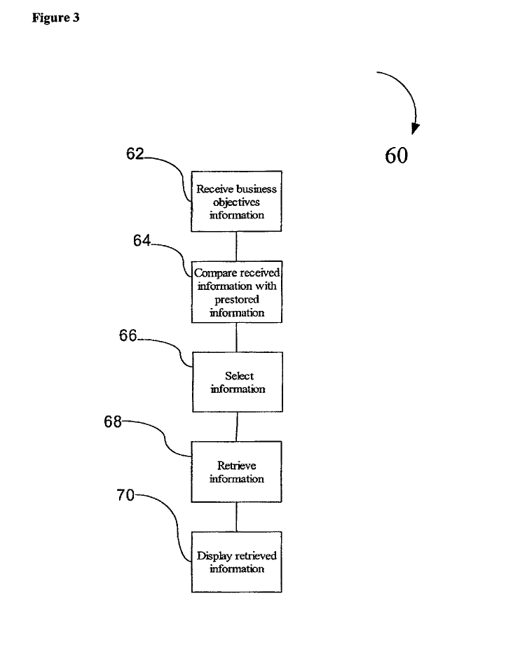

FIG. 3 is a flow diagram 60 for a web-based method for implementing a computer network-based method for disseminating business objectives and tracking progress toward their achievement. System 10 (shown in FIG. 1) receives 62 information relating to business objectives from a user. In one embodiment, the user inputs the information into a device (such as device 14 shown in FIG. 1) which transmits the information to a server (such as server 12 shown in FIG. 1). The business objectives information is received from the user via a graphical user interface as will be described in greater detail below. The received business objectives information includes an identification of a project and of a goal associated with the project. Exemplary project features include, but are not limited to, savings, deflation, cost avoidance, scrap, and other savings, with estimated, planned, and actual figures recorded.

Server 12 compares 64 the received information to pre-stored information accessible by server 12. In one embodiment, the pre-stored information is stored in a database that resides on server 12. In an alternative embodiment, the pre-stored information is stored in a database remote from server 12. The pre-stored information includes business objectives information. Server 12 compares the received information to the pre-stored information to determine if any business objectives information contained in the pre-stored information satisfy the specifications submitted by the user.

System 10 then identifies pre-stored business objectives information that matches the information entered by the user and selects 66 that businesses objectives information. System 10 retrieves 68 business objectives information pertaining to the selected project. In one embodiment, the business objectives information includes a project number. Server 12 then displays 70 the retrieved information on user device 14 so that the user can view the information.

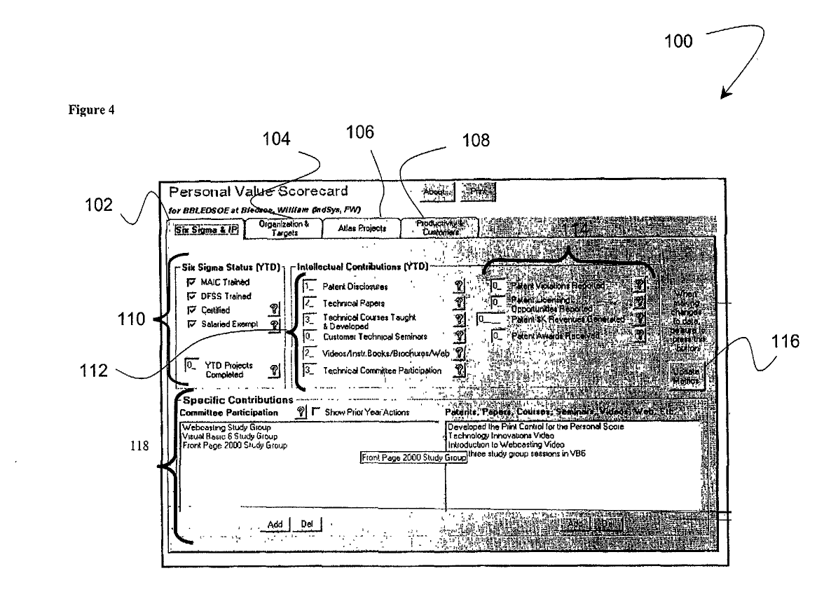

FIG. 4 shows an exemplary embodiment of a personal scorecard Six Sigma and IP page, as depicted in screen shot 100. Screen shot 100 includes a Six Sigma & IP tab 102, an Organization & Target tab 104, an Atlas Projects tab 106, and a Productivity & Customers tab 108. Selection of Six Sigma & IP tab 102 in one embodiment results in screen shot 100, which includes a Six Sigma Status (YTD) display area 110 that includes a set of check boxes to allow the user to indicate whether the user has fulfilled objectives of the Six Sigma program. Screen shot 100 also includes an Intellectual Contributions (YTD) display area 112, which includes a set of text boxes where the user can indicate the number of patent disclosures, technical papers, technical courses, customer technical seminars, videos, instructional books, brochures, and web submissions that the user has contributed in the year. Another text box in display area 112 allows the user to specify the number of technical committees in which the user participated. Screen shot 100 further includes a display area 114 that includes a set of text boxes where the user can indicate how many patent violations were reported, how many patent licensing opportunities were reported, how much patent revenue was generated, and how many patent awards were received year-to-date. Screen shot 100 still further includes an Update Metrics push button 116, selection of which updates metrics. Screen shot 100 also includes a Specific Contributions response area 118, with which the user can specify the details concerning committees on which the user participated, and on patents, papers, courses, seminars, and other contributions the user has made year-to-date. Response area 118 also includes a set of Add and Delete push buttons for adding and deleting items in Specific Contributions area 118. Screen shot 100 also includes a checkbox to cause the display to show contributions from the prior year.

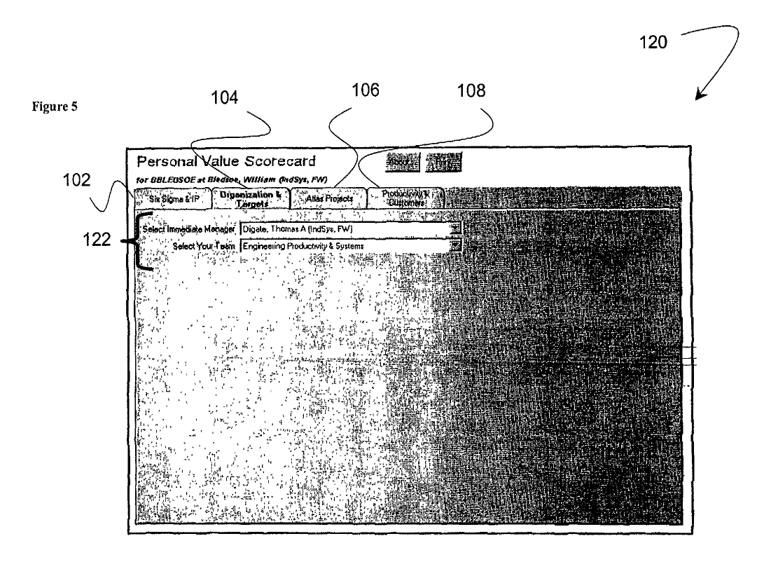

FIG. 5 shows an exemplary embodiment of a personal scorecard Organization & Targets page, as depicted in screen shot 120. Screen shot 120 includes a Six Sigma & IP tab 102, an Organization & Target tab 104, an Atlas Projects tab 106, and a Productivity & Customers tab 108. Selection of Organization & Targets tab 104 in one embodiment results in screen shot 120, which includes a display area 122 that includes a Select Immediate Manager pull down menu and a Select Your Team pull down menu to allow selection of the user's immediate manager and team. Selection of the manager and team enables the system to generate reports for the manager which includes all of their direct or indirectly reporting employees. This functionality enables automatic construction of the organizational hierarchy with no administration.

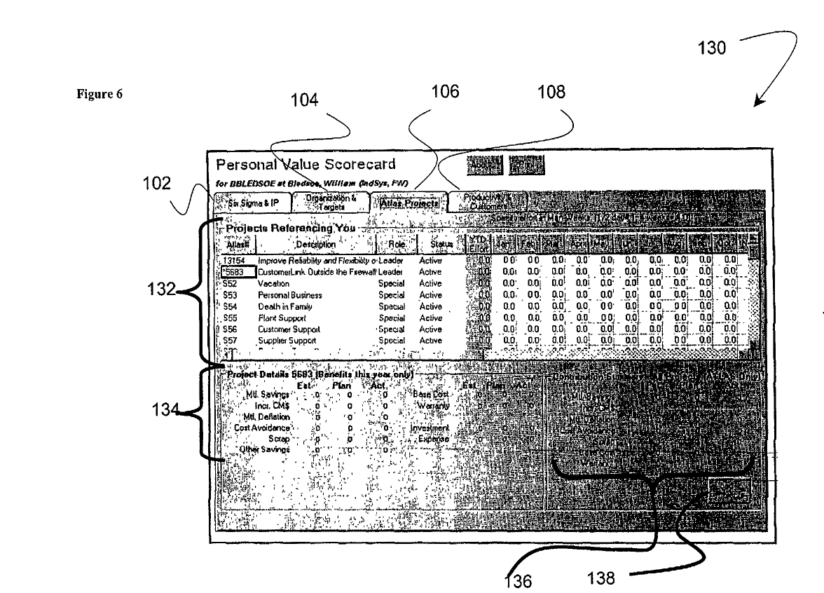

FIG. 6 shows an exemplary embodiment of a personal scorecard Atlas Projects page, as depicted in screen shot 130. Screen shot 130 includes a Six Sigma & IP tab 102, an Organization & Target tab 104, an Atlas Projects tab 106, and a Productivity & Customers tab 108. Selection of Atlas Projects tab 106 results in screen shot 130, which includes a Project Referencing You display area 132 that displays in one embodiment such information as the Atlas number, descriptions, role, status, YTD effort, and months of the year where the user can indicate the allocation of effort over the year to a given Atlas project. Screen shot 130 also includes a Project Details (Benefits this year only) display area 134, that in one embodiment displays savings, deflation, cost avoidance, scrap, and other savings, with estimated, planned, and actual figures recorded. Display area 134 also includes a Base Cost Warranty and an Investment Expense breakout, with estimated, planned, and actual figures recorded. Display area 134 changes to show the details for each project selected in display area 132. In this example, display area 134 shows data for project #5683. Screen shot 130 further includes a Contribution Summary—All Projects (Atlas only) display area 136 that in one embodiment displays savings, deflation, cost avoidance, scrap, and other savings, with estimated, planned, and actual figures recorded. Display area 136 provides a summary of the contribution value for all of the employees” projects shown in display area 132. Lastly, screen shot 130 includes a Load Projects push button 138. Button 138 is selected once to display a customized list of projects in display area 132.

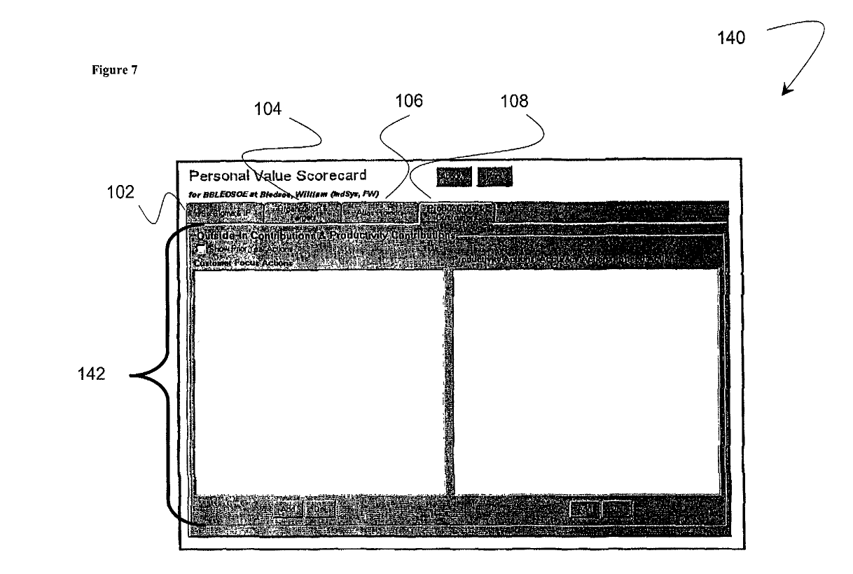

FIG. 7 shows an exemplary embodiment of a personal scorecard Productivity & Customers page, as depicted in screen shot 140. Screen shot 140 includes Six Sigma & IP tab 102, Organization & Target tab 104, Atlas Projects tab 106, and Productivity & Customers tab 108. Selection of Productivity & Customers tab 108 results in display of screen shot 140, which includes an Outside—in Contributions & Productivity Contributions display area 142 that includes within it a Customer Focus Actions list box and a Productivity Actions/Accuracy Actions/Speed Actions list box area. Each list box has associated Add and Delete push buttons to maintain the list contents. Display area 142 also includes a checkbox to cause the display of list box entries from the prior year. Each list box is reset to empty at the beginning of a new year.

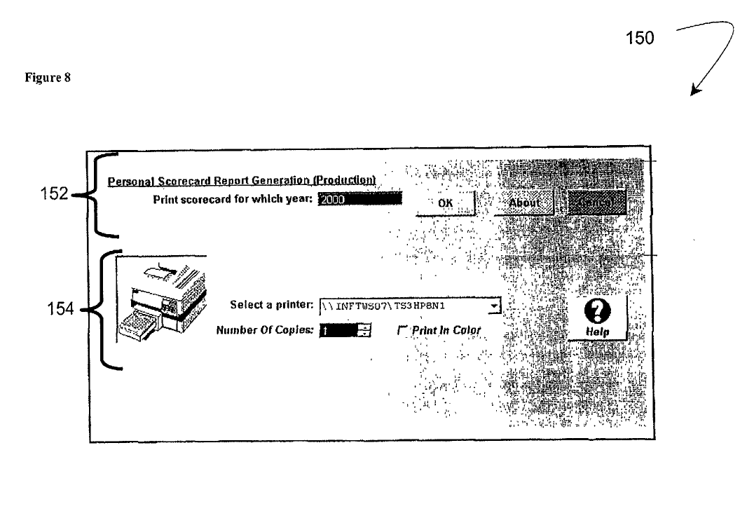

FIG. 8 shows an exemplary embodiment of a personal scorecard Report Generation page, as depicted in screen shot 150. Screen shot 150 includes a Print Scorecard For Which Year text box 152, where the user indicates the year for which the report is to be generated, and a print details selection area 154, where the user indicates the printer to be used, the number of copies to a made, and whether the report is to be printed in color. Not shown in this screen shot is a listbox showing a list of employees. The employee listbox is only shown if the user is a manager. This allows the manager to print a scorecard for one or more employees in his organization.

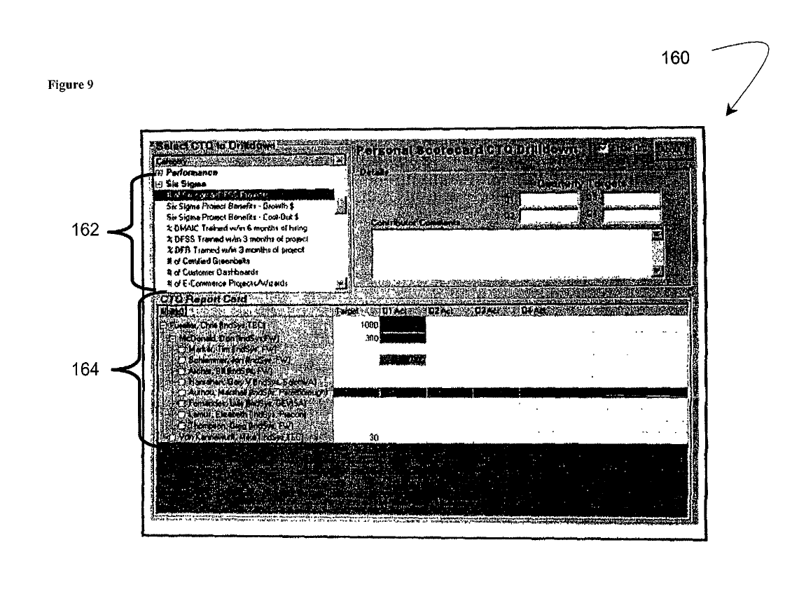

FIG. 9 shows an exemplary embodiment of a Personal Scorecard CTQ Drilldown page, as depicted in screen shot 160. Screen shot 160 includes a Category display area 162 that displays a variety of categories relating to Six Sigma objectives, a set of Quarterly Targets text boxes, and a Contributor Comments text area for narrative comment. Screen shot 160 also includes a CTQ Report Card display area 164 that displays the names of individuals and their targets on a quarterly basis. Display area 162 shows a hierarchical list of CTQ metrics organized by categories. The categories are configured using an administrative tool and the specific metrics are defined using this administrative tool. Additionally, managers allocate specific metrics for members of their team. For each metric, the manager specifies quarterly targets and provides comments to the employee about their expectations. Display area 164 provides a hierarchical display of all employees who have been assigned this metric along with their progress. The actual values are color-coded Red, Yellow, or Green to indicate whether the actual is off, near, or on-target. The top-most manager's actual values are automatically summarized from the immediate reports actual values.

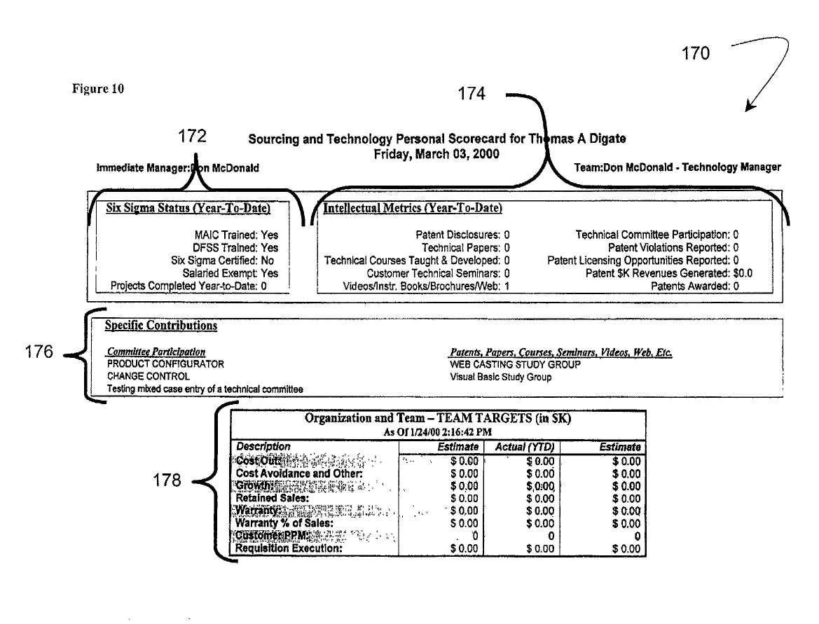

FIG. 10 shows an exemplary embodiment of a personal scorecard report page, as depicted in screen shot 170. Screen shot 170 includes a Six Sigma Status (Year-to-date) display area 172 that displays the user's progress toward meeting Six Sigma goals, and an Intellectual Metrics (Year-to-date) display area 174 that displays the user's intellectual contributions in the form of patent disclosures, technical papers, and the like. Screen shot 170 also includes a Specific Contributions display area 176 to display details of the user's specific contributions. Screen shot 170 also includes an Organization and Team—Team Targets display 178 that summarizes progress toward team targets. This report represents the data entered by the user on the displays discussed previously.

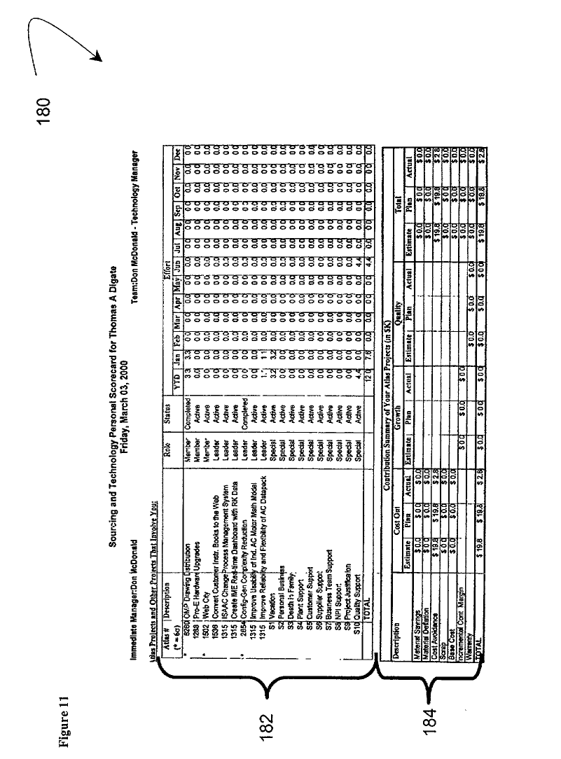

FIG. 11 shows a continuation of the personal scorecard report page shown in FIG. 10, as depicted in screen shot 180. Screen shot 180 includes an Atlas Projects and Other Projects That Involve You display area 182 to display the Atlas number, description, role, status, and effort by month for each of a variety of Atlas projects. Screen shot 180 also includes a Contribution Summary of Your Atlas Projects display area 184 that displays the description, cost out, growth, quality, and total sum for material savings, material deflation, cost avoidance, scrap, base cost, incremental contingent margin, and warranty.

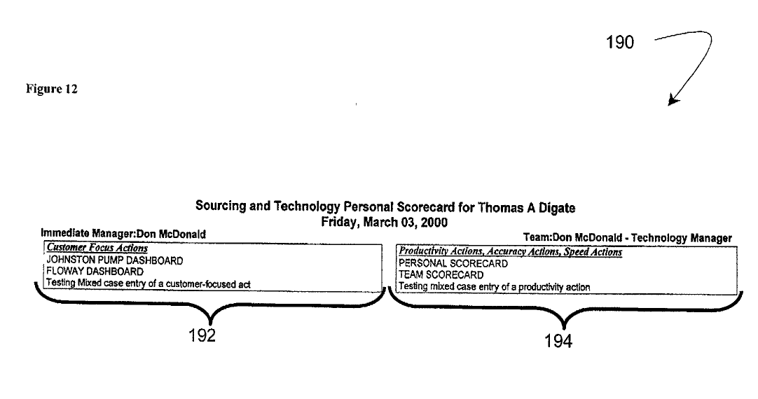

FIG. 12 shows a further continuation of the personal scorecard report page shown in FIG. 10, as depicted in screen shot 190. Screen shot 190 includes an Customer Focus Actions display area 192 to display actions for a selected individual. Screen shot 190 also includes a Productivity Actions, Accuracy Actions, Speed Actions display area 194 that displays the various applicable scorecards.

In use, system 100 provides global access to the business objectives of an organization, allowing the rapid dissemination of those objectives to employees around the world and a way of tracking the progress of those employees toward meeting those objectives. System 100 allows managers to ensure that all employees reporting to them know and are working toward their assigned objectives, and to allow managers and employees alike to track individual and collective progress in real time. In so doing it further allows managers and employees to prepare periodic assessments of employee performance in an efficient and accurate fashion.

The personal scorecard system provides for not only gathering employee information, but also for summarizing and retrieving the information. The personal scorecard system offers managers an easily grasped overview of a team's progress, as well as the ability to “drill down” into the details of how the team achieved the results. Because changes are reflected instantaneously, the scorecard system allows managers to take any necessary action to assure that a team meets its business objectives.

The personal scorecard system also allows the manager to tailor global or personal goals for the particular organization. The very act of defining these goals immediately makes these goals available to his employees, without the intense manual effort of dispersing and tracking both organizational and team goals. Employees are more likely to update their personal information as it happens instead of waiting for the periodic reviews. The manager and employee also have the opportunity to discuss performance on a more timely and frequent basis, instead of annually. Furthermore, the employee can always know where he or she stands in relationship to what is expected of him or her.

While the invention has been described in terms of various specific embodiments, those skilled in the art will recognize that the invention can be practiced with modification within the spirit and scope of the claims.

1. A method of communicating information relating to a business objective between coworkers through use of a network that includes a server and at least one device connected to the server via a network, said method comprising the steps of:
receiving business objective information from a user via the device;
storing the received information in a data storage device;
comparing the received information with previously stored information;
generating output data relating to the business objective information; and
displaying the output data to the user via the device.

2. The method of claim 1 wherein said step of receiving business objective information comprises the step of receiving business objective information for one or more coworkers.

3. The method of claim 1 wherein said step of receiving input data comprises the step of generating a report of progress toward achieving the business objective.

4. The method of claim 3, wherein said step of generating a report comprises the step of generating a report relating to progress toward a business objective made by one or more coworkers.

5. The method of claim 1 wherein said step of providing the server with a user interface comprises the step of providing a selection page for a user to specify the business objective.

6. The method of claim 1 wherein said step of generating output data comprises the step of generating a report of progress toward a business objective.

7. The method of claim 6, wherein said step of generating a report comprises the step of generating a report relating to a performance appraisal.

8. The method of claim 1 wherein said step of generating output data comprises the step of assessing progress toward a business objective.

9. The method of claim 8 wherein said step of assessing progress toward a business objective comprises the step of depicting progress toward a business objective on a graphic display.

10. The method of claim 1 wherein said step of generating output data comprises the step of generating a report summarizing progress toward a business objective.

11. A system for communicating information relating to a business objective between coworkers, said system comprising:
at least one computer;
a server configured to read input data relating to the business objective and to output data relating to the business objective;
a network connecting said server to said at least one computer; and
a user interface installed on said at least one computer configured to allow a user to input the data to said server relating to the business objective and to receive the data from said server relating to the business objective.

12. The system of claim 11, wherein said server further configured with a selection page for a user to specify the business objective of at least one coworker.

13. The system of claim 11 wherein the output data comprise a report of the progress toward a business objective.

14. The system of claim 13 wherein the report comprises a performance appraisal.

15. The system of claim 11 wherein the output data comprises an assessment of progress toward a business objective.

16. The system of claim 15, wherein the assessment of progress is depicted in a graphic display.

17. The system of claim 11 wherein the output data comprise a report summarizing progress toward a business objective.

18. The system of claim 11 wherein said server is further configured to store input data relating to each of a plurality of business objectives.

19. The system of claim 11 wherein said server further configured to allow the user to submit the input data via a network selected from the group consisting of the Internet and an intranet.

20. The system of claim 11 wherein said network is the Internet.

21. The system of claim 11 wherein said network is an intranet.

22. The system of claim 11 wherein said network is one of a wide area network and a local area network.

23. The system of claim 11 wherein said user interface is configured with at least one input field for receiving and storing the input data relating to a business objective.

24. The system of claim 11 wherein said server is configured to read the input data and to output data on the selected business objective, the output data including a graphic display of progress toward achieving the business objective.

25. A computer programmed to:
prompt a user to access a network-based business objective application;
prompt a user to enter business objective information;
compare the entered information with information stored in a computer readable medium; and
output data relating to business objectives.

26. A computer in accordance with claim 25 further programmed to generate a report on progress toward achieving the business objective.

27. A computer in accordance with claim 25 wherein said computer programmed to prompt a user to enter business objective information by transmitting a selection page for the user to specify the business objective.

28. A computer in accordance with claim 25 further programmed to generate a performance appraisal report.

29. A computer in accordance with claim 25 further programmed to graphically display a depiction of progress toward meeting a business objective.

30. Apparatus comprising:
means for accessing a database including business objective information;
means for prompting a user to access the database;
means for receiving business objective information input by the user;
means for storing the received information in the database;
means for comparing the received information with previously stored objective information; and
means for displaying to the user information pertaining to the received information.

31. Apparatus in accordance with claim 30 further comprising means for generating a report of progress toward achieving a business objective.

32. Apparatus in accordance with claim 30 further comprising means for generating a report relating to a performance appraisal.

33. Apparatus in accordance with claim 30 further comprising means for depicting progress toward a business objective on a graphic display.
